(19) United States
(12) Patent Application Publication
(10) Pub. No.: US 2020/0089594 A1
(43) Pub. Date: Mar. 19, 2020

(54) ARTIFICIAL INTELLIGENCE FOR LOAD TESTING

(71) Applicant: Electronic Arts Inc., Redwood City, CA (US)

(72) Inventors: Jianjun Zhou, Belmont, CA (US); Amit Kumar Mathur, Bellevue, WA (US)

(21) Appl. No.: 16/136,105

(22) Filed: Sep. 19, 2018

(51) Int. Cl. G06F 11/36

(52) U.S. Cl. CPC G06F 11/368; G06F 11/3664; G06F 11/3688; G06F 11/3684

(57) ABSTRACT

A system is configured to automatically update load tests after software is updated and tested. The system accesses test logs to determine changes in sequences of events. An event model is updated based on the changes. Load tests are run, and the load tests include simulating clients that perform events according to the sequences in the event model.

### FIELD

This disclosure relates to artificial intelligence systems for load testing.

### BACKGROUND

In software development, load testing is performed to test the software and hardware under various load conditions. During software development, the software can change as the software is updated to fix bugs, add or remove features, change functionality, etc. Such changes can cause earlier load testing systems to become outdated or provide incomplete load coverage.

### SUMMARY

The systems, methods, and devices in this disclosure each have several innovative aspects, no single one of which is solely responsible for all of the desirable attributes disclosed herein. Details of the one or more implementations of the subject matter described in this specification are set forth in the accompanying drawings and the description below.

Some aspects feature a computer system for automatically updating load tests, the computer system comprising one or more non-transitory, computer-readable storage mediums storing computer readable instructions and one or more processors configured to execute the computer readable instructions to perform operations comprising: accessing application test logs generated based on an updated version of software; comparing events from the application test logs to events in a previous event model; based at least in part on the comparison, generating an event model with at least one update to the previous event model; and load testing one or more servers. The load testing includes: instantiating a plurality of simulated clients, each simulated client configured to execute a test application that causes the simulated client to send communications with the one or more servers according to the events in the event model, wherein the communications are a load to the one or more servers; and processing, by the one or more servers, the communications sent by the simulated clients.

Various embodiments of the computer system may include one, all, or any combination of the following features. The one or more processors are configured to execute the computer readable instructions to perform operations further comprising: performing a plurality of tests on the software, wherein a test client communicates to a test server during the tests; and generating the application test logs that include the events and times that the events occurred, wherein the events include communications sent from the test client to the test server. The event model includes a plurality of branches splitting events in the event model into various paths of events. The event model further includes: indications of timings for the events in the event model; and statistical distributions of how often the various paths of events are taken. The at least one update includes at least one of: a new event in the event model; a new branch in the event model; a changed order of events in the event model; a changed branch probability in the event model; or a changed timing of an event in the event model. One or more new events are identified based on the comparison, the one or more new events occurring in at least one of the application test logs due and being missing from the previous event model; and the at least one update includes the one or more new events. The one or more new events occur after a scenario in some but not all of the application test logs; and the at least one update includes the one or more new events as a new branch in the event model. The one or more processors are configured to execute the computer readable instructions to perform operations further comprising: receiving a plurality of tagged application test logs, each tagged application test log including a plurality of scenario tags, each scenario tag applied to a sequence of one or more events; and generating the previous event model based on the tagged application test logs, the previous event model including branch statistics based on the tagged application test logs. The application test logs are compared to the previous event model to determine a new scenario not present in the previous event model, the new scenario including a sequence of events; and the at least one update includes the new scenario. The one or more processors are configured to execute the computer readable instructions to perform operations further comprising: generating data for displaying a graphical user interface showing at least two of: a video output of the software while the new scenario is being executed; events included in the new scenario; and portions of the event model included in the at least one update. The one or more processors are configured to execute the computer readable instructions to perform operations further comprising: receiving an indication of at least one of: a confirmation that the new scenario is correct or a tag describing the new scenario.

Some aspects feature a method for an artificial intelligence system to provide load testing, the method comprising: accessing application test logs generated based on an updated version of software; comparing events from the application test logs to events in a previous event model; based at least in part on the comparison, generating an event model that includes at least one update to the previous event model; and load testing one or more servers, wherein the load testing includes: running the one or more servers; instantiating a plurality of simulated clients, each simulated client configured to execute a test application that causes the simulated clients to send communications to the one or more servers according to events in the event model, wherein the communications are a load on the one or more servers; and processing by the one or more servers, the communications sent by the simulated clients.

Various embodiments of the method can include one, all, or any combination of the following features. Performing a plurality of tests on the software, wherein a test client communicates to a test server during the tests; and generating the application test logs that include the events and times that the events occurred, wherein the events include communications sent from the test client to the test server. The event model includes a plurality of branches splitting the events in the event model into various paths of events. The event model further includes: indications of timings for the events in the event model; and statistical distributions of how often the various paths of events are taken. The at least one update includes at least one of: a new event in the event model; a new branch in the event model; a changed order of the events in the event model; a changed branch probability in the event model; or a changed timing of an event in the event model. One or more new events are identified based on the comparison, the one or more new events occurring in at least one of the application test logs due and being missing from the previous event model; and wherein updating the event model includes adding the one or more new events to the event model. Receiving a plurality of tagged application test logs, each tagged application test log including a plurality of scenario tags, each scenario tag applied to a sequence of one or more events; and generating the previous event model based on the tagged application test logs, the previous event model including branch statistics based on the tagged application test logs. The application test logs are compared to the previous event model to determine a new scenario not present in the previous event model, the new scenario including a sequence of events; and the at least one update includes the new scenario. Generating data for displaying a graphical user interface showing at least two of: a video output of the software while the new scenario is being executed; events included in the new scenario; and portions of the event model included in the at least one update.

### BRIEF DESCRIPTION OF THE DRAWINGS

FIG. 1A shows a flowchart for an example software development cycle.

FIG. 1B shows a flowchart of an example process for using AI to update an event model.

FIG. 1C shows a flowchart of an example process for using the event model to perform load testing.

FIG. 2A shows an example system with servers under load.

FIG. 2B shows a test environment for testing servers with a simulated load of clients.

FIG. 3 shows an example system with artificial intelligence for automatically updating event models used by load tests.

FIG. 4 shows an example user interface for recording and reviewing software usage.

FIG. 5 shows a part of an example event model.

FIG. 6 shows a part of an example scenario model.

FIG. 7 shows an example event model with a new event.

FIG. 8 shows an example event model with a new scenario.

FIG. 9 shows an embodiment of a hardware configuration for a computing system.

### DETAILED DESCRIPTION

### Introduction

An artificial intelligence (AI) system is disclosed herein to help the software and/or hardware load testing process. During the software development process, the software can be repeatedly edited and tested. In response to each test, an AI system can automatically determine if revisions to a load test are appropriate, and if so, automatically revise the load test, saving significant amounts of labor and greatly expediting the software development process. The AI system can be implemented to use techniques that are different from techniques that people use to update load tests.

The software development process can be long and tedious. Software development teams for large software projects can include tens, hundreds, or even thousands of programmers. Each programmer may be responsible for coding or implementing specific parts of the software. The software may be repeatedly edited for various reasons, such as to fix bugs in the code, add or remove features and functionality, change the design of the software, change the software in view of user feedback, and the like.

Alongside the software development team, a software testing team can test the software during development. One aspect of testing includes load testing. Load testing can be performed to stress test the software and/or hardware under various load conditions, especially for software that includes a component executed on a server. For example, some software may include client-side software that communicates with server-side software.

As used herein, the term “software” will generally be used to refer to any of the following if applicable in context and unless otherwise specified: client-side software, server-side software, either or both client-side software and server-side software, or stand-alone software. Although some examples will be discussed with respect to software communications between clients and servers, it will be understood that the technology can also be implemented for coverage testing to make sure that a proper distribution of software functionality is covered in tests, including coverage testing for software executing on one computer system (e.g., without communications to a second computer system).

Server-side software is often designed to be capable of responding to a predicted load of communication from clients. The predicted load on a server may include a quantity (such as tens, hundreds, thousands, millions, billions, or more) or rate (such as per second, per minute, per hour, and the like) of communications events (such as login requests, requests for data, requests to write data, requests to execute various API's, and the like) in various sequences. Load tests can be written such that a predicted load and/or variations thereof may be used for testing.

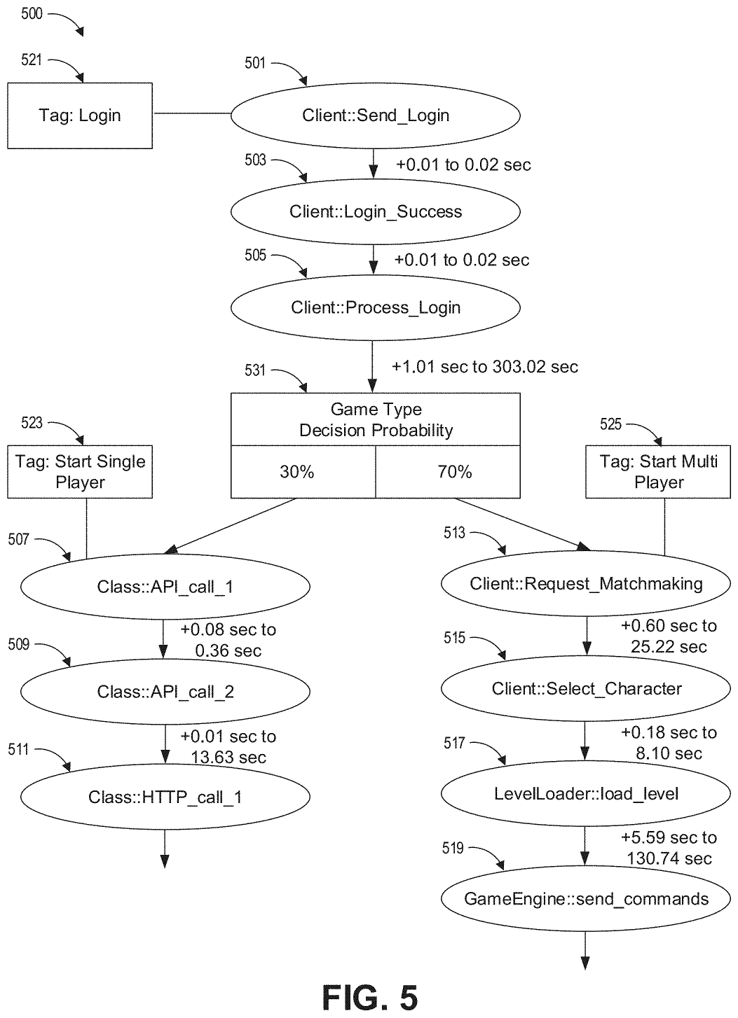

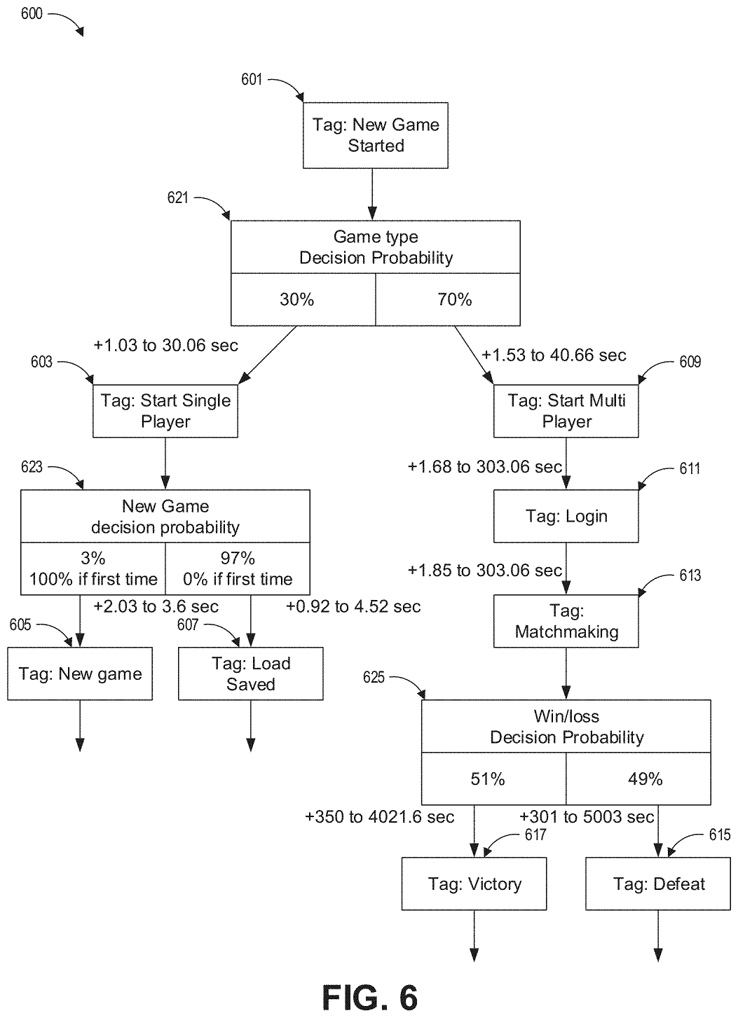

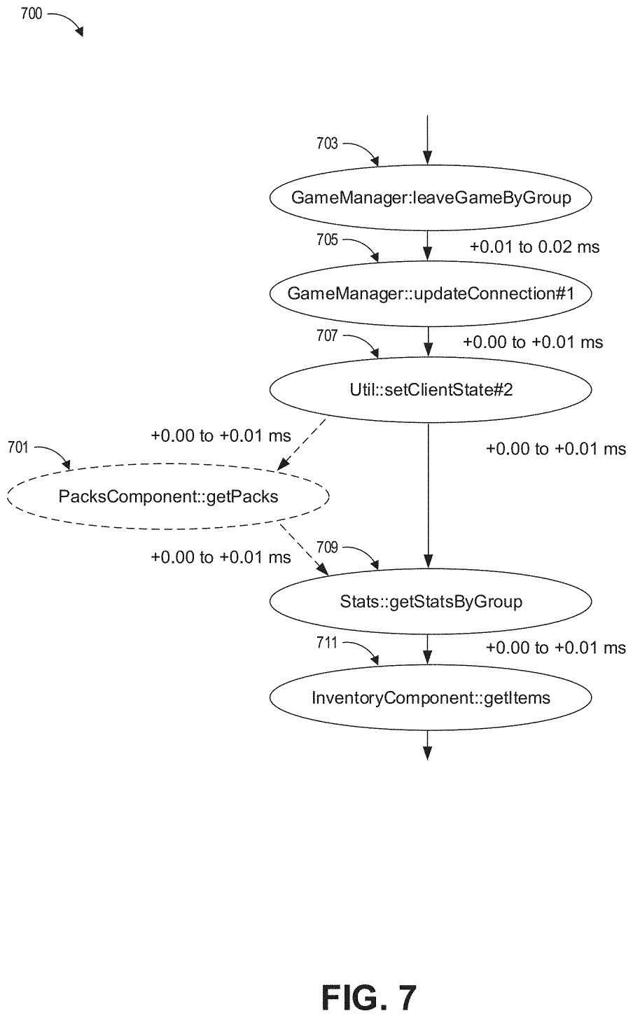

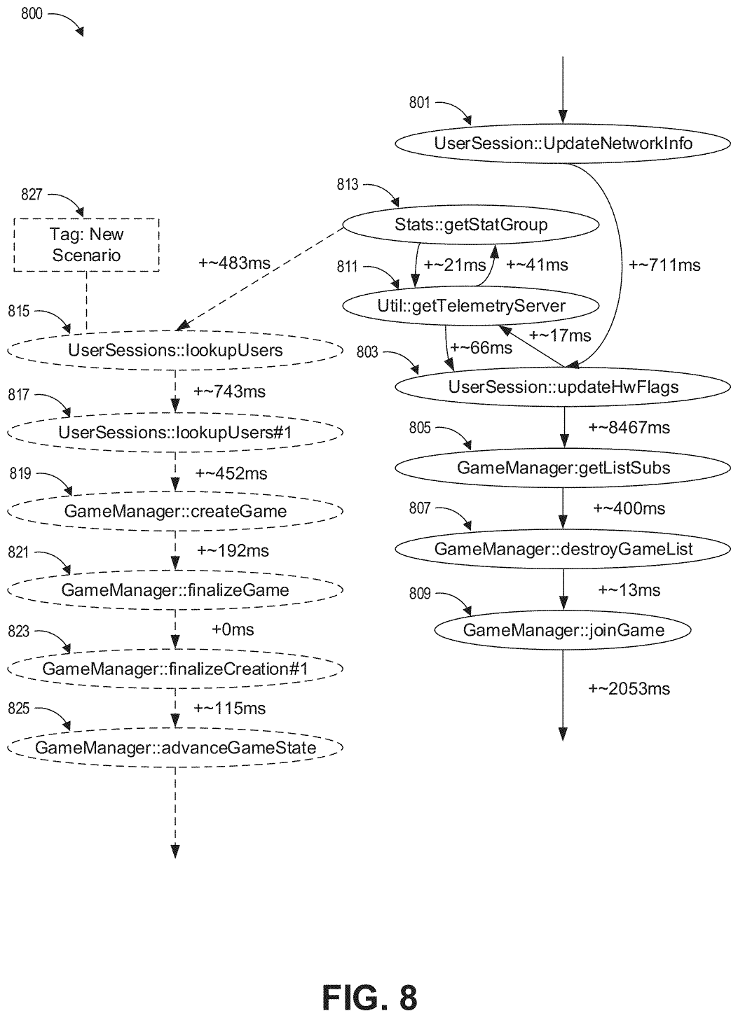

As the software is developed, the code may be continuously re-written, edited, and updated. In some environments, the software code may be updated periodically, such as every day, as developers fix bugs in the code, add or remove features and functionality, change the design of the software, change the software in view of user feedback, and the like. A load testing team of programmers may be tasked with the responsibility of updating load tests in response to each change to the software. A load test can include a set of instructions for generating certain sequences and/or distributions of events. The load tests can include and/or reference a model (such as an event model or scenario model) specifying sequences and/or distributions of events or scenarios. Although examples of models in the context of an event model or scenario model are illustrated as flowcharts in FIG. 5, FIG. 6, FIG. 7, and FIG. 8, the models are not limited to graphical flowcharts, but models instead refer to any type of data structure (such as custom data objects, tree structures, tables, linked lists, array structures, and the like) that can be used to represent sequences of events or scenarios.

If a new event (such as a specific API call) is added to the software during development, then the load test (including the data structure that is in or linked to the load test) can be updated to include that new event as part of the test (such as by having a large number of clients execute the specific API call to the server). If an event is removed from the software, then the load tests should be updated to remove that event. If the software is otherwise modified, such as to fix bugs or change the design logic, then the type, frequency, and/or sequence of communications between clients and servers may change. In order to properly test updated software under load conditions to promptly find additional bugs, the load test team may be tasked with updating the load tests as frequently as the software development team updates the software.

Delays in updating the load tests can delay software development. Often, one person or only a small team of load testing team of programmers may be overwhelmed by the sheer quantity of code updates and fall behind schedule. The process of determining how and what to update in the load tests can be tedious and time consuming. Each time the software is updated, the load testing team may be tasked with reviewing changelogs to determine what the software development team did. For example, if new functionality was added, then the load tests should be updated to stress test the new functionality, and if old functionality was removed, then the load tests should be updated to remove the old functionality. For example, the load testing team may attend planning meetings to discuss plans for the software development team to add major new functionality X, Y, and Z by the end of the month. Based on the meeting, the load testing team can prepare to have load tests implementing the new functionality ready at that time. Other times, software changes may be unintentional or undocumented. The load testing team may still be responsible for discovering and load testing such changes. In large projects where hundreds or thousands of programmers may update hundreds, thousands, or millions of lines per code every day, load testing teams can easily fall behind in updating tests. For many software projects, it can be prohibitively costly to increase the size of load testing teams to match the sizes of software development teams.

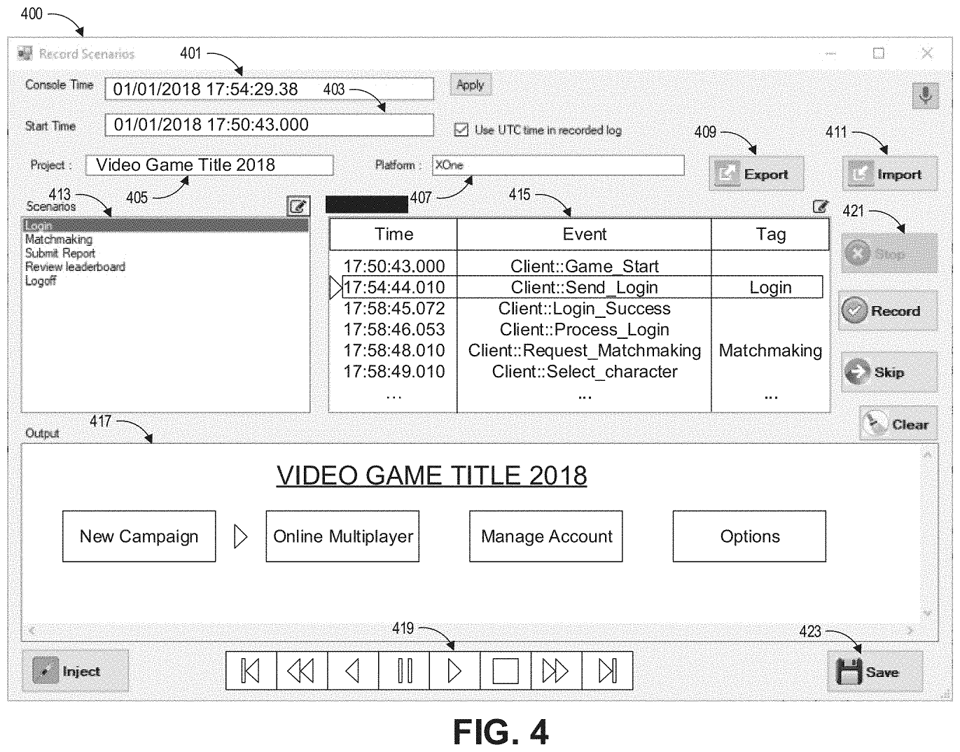

To alleviate the burden on the load testing team, an AI system can be used to automatically update the load tests. From an initial software version, the load test team can mark scenarios, which include sequences of events that occur during software execution. Different scenarios include different sequences of events. A scenario usually includes the same sequences of events or minor variations to a sequence of events that are repeatedly included when the scenario is performed, such as in test logs. An example user interface for marking scenarios is shown in FIG. 4. A model (such as a tree) of events and/or scenarios can be generated as a data structure. Example event models and scenario models are shown in FIG. 5 and FIG. 6.

It is difficult to make an AI system attend planning meetings or interpret changelogs like a person can. Instead, for each software update, the AI system can be configured to analyze logs of the software execution and compare the logs to the model. Any differences in the sequence of scenarios and/or events can be optionally flagged for review by the load test team for. Examples of differences are shown in FIG. 7 and FIG. 8. Based on the differences, the model can be updated to include the new scenarios and/or events, update a distribution of timings, and/or update branch statistics. The process can be repeated each time that the software is updated, and load tests can be executed using the model as a basis for events to occur during the load test.

By comparing test log data to the model, the AI system can intelligently detect what changes were recently implemented. Furthermore, the AI system can do so without performing many tasks that the load test team used to perform, such as attending planning meetings or interpreting changelogs. In doing so, the AI system can even detect undocumented changes in functionality. Optional supervised review can be implemented to double check that the AI system's detected changes should be load tested. By using the AI system, the workload of the load test team can be significantly reduced, and the software development process can be completed much faster, even without increasing the number of people on the load testing team. The AI system also has the advantage of being able to detect undocumented changes.

For purposes of providing an overview, certain advantages have been described herein. It is to be understood that not necessarily all such advantages may be achieved in accordance with any particular embodiment. Thus, the various embodiments can be carried out in various manners that achieve or optimizes one advantage or group of advantages as taught herein without necessarily achieving other advantages as may be taught or suggested herein.

### Example Process

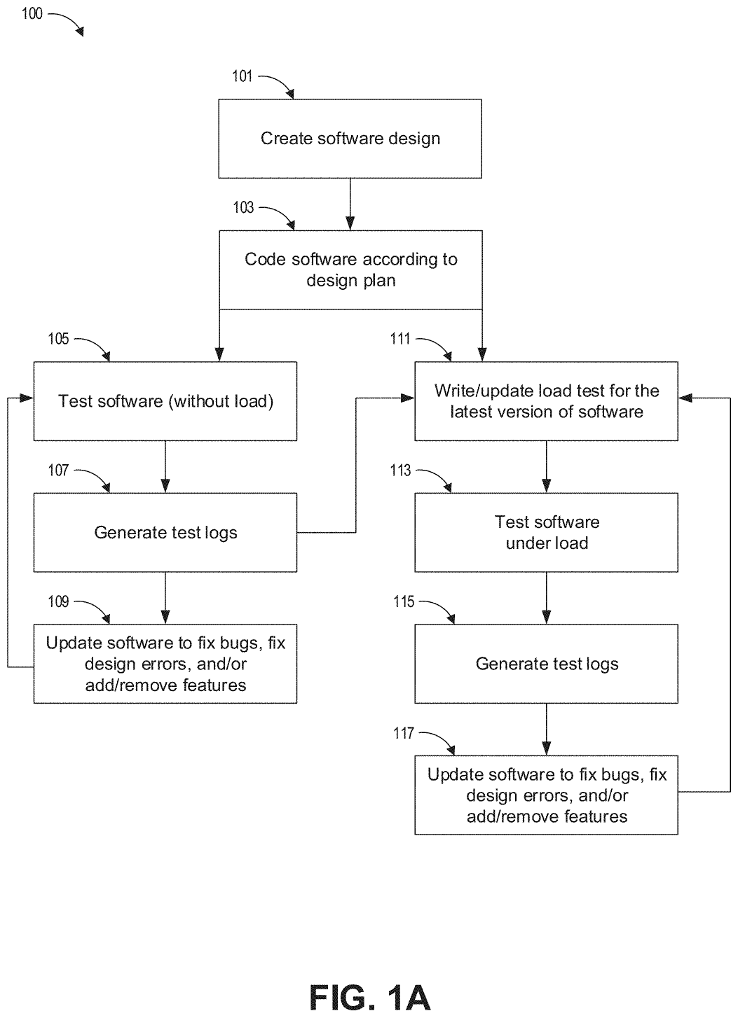

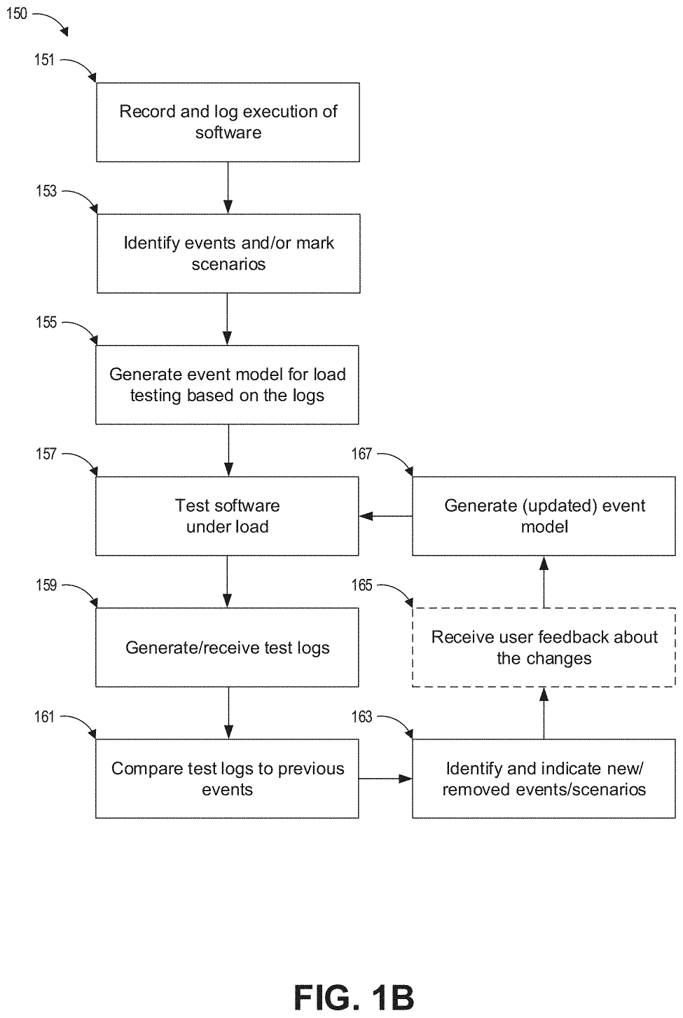

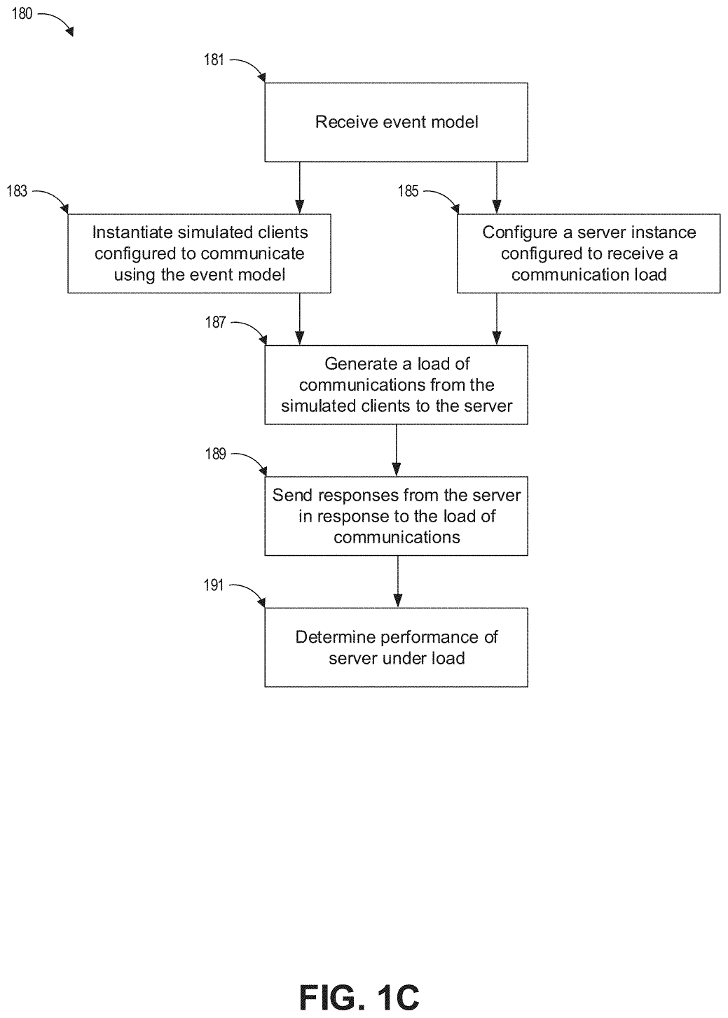

FIG. 1A shows a flowchart 100 for an example software development cycle. At block 101, a software design is created.

At block 103, the software can be coded according to the design. For large software projects, block 103 can include coding a portion of the software or beginning to code portions of the software. Block 103 can proceed to block 105 and to block 111.

At block 105, the software can be tested for bugs, features and functionality, design, user feedback, and the like. Some types of testing can be performed without load testing.

Individual instances of client-side software can be repeatedly tested. The client software may be tested by communicating against an instance of a server scripted to provide limited functionality to support specific tests, tested against an unloaded or low-load server, and the like.

Server-side software can also be tested. For example, the server-side software may be configured to receive scripted sequences of communications from a client to test that the server responds correctly. These tests can be performed without loading the server with many clients.

Many instances of block 105 can be performed at the same time, such as by running periodic or routine testing batches. The tests can be performed overnight, whenever the software is updated, and/or at other various times. Block 105 can proceed to block 107.

At block 107, test logs can be generated from the tests in block 105. The test logs can include events and times that the events occur during testing or execution of the software. Events can include any action or communication by the software that can be simulated or replicated for load testing. For example, client-side software may make API calls to a server, hypertext transport protocol (HTTP) communications to a server, function calls, and the like. Block 107 can proceed to block 109 and to block 111.

At block 109, the software can be updated to fix bugs in the code, add or remove features and functionality, change the design of the software, change the software in view of user feedback, and the like. The updates can be saved in to a repository, thereby updating the software for a next round of testing. Block 109 can proceed back to block 105, continuing the testing cycle until the software development and testing are complete.

At block 111, a load test can be written or updated for the latest version of software. The load test can include simulating multiple clients in communication with a server such that the server experiences a load of client activity. A load test can include or reference an event model that indicates the events to be executed, the sequence of events, the timing of events, distribution of events, branches, and the like. Additional details relating to block 111, including implementing an AI system to update the event model, are further described with respect to FIG. 1B. Block 111 can proceed to block 113.

At block 113, the software can be tested under load. This can include, for example, testing server-side software to fix bugs in the code, add or remove features and functionality, change the design of the server software, and the like. For example, various tests can be run on the server while the server receives communications from a load of clients. The communications can be generated by simulated instances of clients based on the event model. The load tests can be performed overnight, whenever the software is updated, and/or at other various times. Block 113 can proceed to block 115.

At block 115, test logs can be generated from the tests in block 115. The test logs can include events that occur during load testing. Block 115 can proceed to block 117.

At block 117, the software can be updated to fix bugs in the code, add or remove features and functionality, change the design of the software, change the software in view of user feedback, and the like. The updates can be saved or changed in to a repository, thereby updating the software for a next round of testing. Block 117 can proceed back to block 111, continuing the testing cycle until the software development and testing are complete.

FIG. 1B shows a flowchart 150 of an example process for using AI to update an event model. Parts of FIG. 1B may overlap with and/or provide more detail about parts of FIG. 1A. Some parts of FIG. 1B can be executed by one or more processors executing instructions stored on one or more non-transitory computer-readable storage devices.

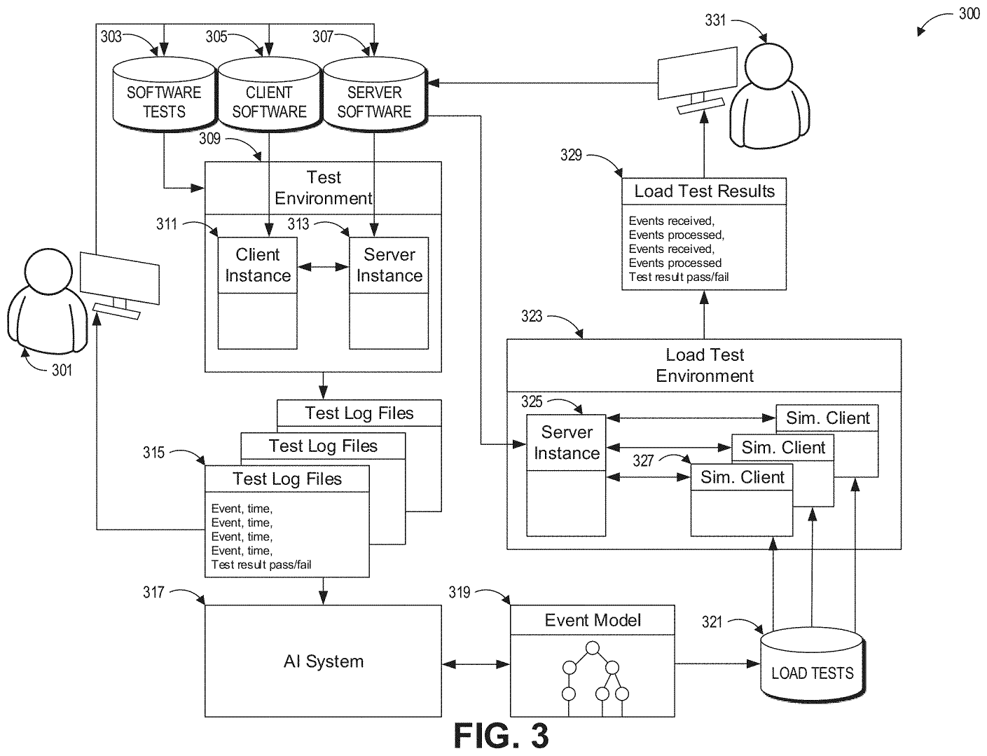

At block 151, one or more computer systems can record and log execution of the software. In some cases, the software can be executed during testing (such as in block 105 or 113). The software can also be executed by alpha or beta testers. As further illustrated in FIG. 3, the software can be executed on client computer systems. A plurality of logs can be generated, the logs including events. Block 151 can proceed to block 153.

At block 153, the events from the logs of block 151 can be analyzed to identify sequences of events. Scenarios can also be marked. A scenario can include a plurality of events in a sequence, and the scenarios can be marked to indicate different things that are happening during the course of software execution. The various scenarios can be marked with tags to identify what is happening in the software for human comprehension. It can be helpful to indicate the various scenarios that may be different during various executions of the software. A user interface for analyzing the logs is shown in FIG. 4. Some examples of scenarios in a video game are shown in FIG. 4 and in FIG. 6. In some embodiments, marking the scenarios can be optional or omitted.

At block 155, an event model or scenario model can be generated based on the logs. The load test can include code to cause a simulated load based on the event model or scenario model. In many cases, it can be prohibitively expensive to test actual hardware loads of thousands or millions of client computers connecting to a server, and the client code may be buggy, incomplete, or under development. Instead, when load testing the server, instances of the clients can be simulated to communicate with the server by generating sequences of communication events according to the event model. The load tests can instantiate simulations of many clients and/or cause the server to behave as if receiving communications from the many clients.

The load tests can include or reference a data structure for an event model. An example visualization of an event model is shown in FIG. 5. The event model can include sequences of the events that occurred in the logs from block 151 or from block 107 of FIG. 1A. The event model can also include scenario labels indicating an event that starts the scenario and/or a plurality of events included in the scenario. For example, a first event or a group of events that occur when a user logs in to an account can be tagged as part of a “log in” scenario. The event model can also include timing data indicating times or distributions of times that events occur. For example, the timing data can indicate that a second event occurred 10 milliseconds after a first event, or that the second event occurs randomly between 5 to 15 milliseconds after a first event, or that the second event occurs based on a Gaussian distribution of times centered about 10 milliseconds with a 5 millisecond standard deviation. The event model can also include data about the historical occurrence of events based on the logs. For example, the event model can indicate that an event always occurs (for example, a start-up event, a log-in event, and the like), that an event has occurred in XX out of YY logs, or that an event has occurred in 55% of logs. The event model can include data indicating the historical occurrence of sequences of events based on the logs. For example, the event model can indicate that an event E53 was followed by event E54 in XX out of ZZ logs, and that event E53 was followed by event E73 in YY out of ZZ logs.

In some embodiments, the load test can additionally or alternatively be generated and/or updated based on logs received from block 107 of FIG. 1A. Block 155 can proceed to block 157.

At block 157, the software can be tested under load. The load can be generated based on the recently generated or updated event model such that the load includes sequences and/or distributions of events described in the recently generated or updated event model. The software can be tested for bugs, features and functionality, design, user feedback, and the like, such as described with respect to block 113 of FIG. 1A. Load testing the software can also include determining the performance of the software or servers, such as the rate at which servers can process communications, response times, dropped packets, etc. Block 157 can proceed to block 159.

At block 159, test logs can be generated as part of testing during block 157. The test logs can additionally or alternatively be received, for example, from block 107 of FIG. 1A. The test logs can indicate times and sequences of events that occurred during load testing. Block 159 can proceed to block 161.

At block 161, the events in the test logs can be compared to the previous events. This can be done, for example, by comparing sequences of events in the test logs to sequences of events from the latest event model. This can also be done, for example, by comparing the sequences of events in the test logs to sequences of events from earlier test logs. Block 161 can proceed to block 163.

At block 163, new and/or removed events can be identified and/or indicated based on the comparison at block 161. Block 163 can proceed to block 165.

At block 165, optional user feedback about the changes can be received. The load test team can review the identified changes from block 163 to approve or reject the changes for future load testing. If a new scenario was identified at block 163, then a tag for labeling the new scenario can be received. If a new sequence of events was identified at block 163, then user feedback indicating whether or not the new sequence of events constitute a new scenario can be received. The feedback can be saved and automatically applied when a same or similar changes to events are identified in the future. Block 165 can proceed to block 167.

At block 167, the event model can be generated based on the identified changes from block 165. The event model generated at block 167 can be an updated version of a previously generated event model with at least one change. If user feedback was received at block 167, then the event model can also be updated based on the user feedback to include approved changes, approved scenarios, and/or new tags without including the rejected changes. Updating the event model can include modifying the event model to add new events, new scenarios, and new tags. Updating the event model can also include changing sequences of events, changing the timing distribution of events, and/or changing logged occurrences of events. In some embodiments, distributions of events or timings can be weighted more heavily or entirely toward more recent occurrences to load test recently updated or recently added features.

Block 167 can proceed to block 157 so that the software can be tested under load again, where the load is generated based on the updated event model. Accordingly, the testing cycle can continue until software testing is completed.

FIG. 1C shows a flowchart 180 of an example process for using the event model to perform load testing, such as described in block 113 of FIGS. 1A and 1n block 157 of FIG. 1B.

At block 181, an event model is received. The event model can be generated at block 155 or generated at block 167 of FIG. 1B.

At block 183, a plurality of simulated clients can be instantiated. The simulated clients can be configured to communicate using the event model. To communicate using the event model, the simulated clients can generate communications according to a sequence, timing, and/or decisions in the event model. The simulated clients can be configured to communicate with one or more instances of servers. In some embodiments, hundreds, thousands, millions, or greater quantities of clients or more can be simulated.

At block 185, one or more server instances can be instantiated. The instances of the server can be virtual servers, or physical servers can be used. The servers can be executed on one or more types of physical hardware servers that will be used when the software is released. Networking equipment and software that enables the clients to communicate with the servers can also be configured and used during testing.

At block 187, the simulated clients can generate and communicate sequences of communications to the virtual and/or physical servers such that the servers experience a load. The load of communications can be transmitted to the one or more servers such that the servers are stressed by the load. Sequences of communications from various simulated clients can be overlapping with, simultaneous with, and/or temporally proximate to other sequences of communications from other clients.

At block 189, the server can send responses to the clients in response to the load of communications. Block 189 can overlap with block 187.

At block 181, the performance of the server under load can be tested. This can include tracking and analyzing, for example, whether responses from the server were properly sent, whether requests were dropped, server latency, response times, etc. If one or more servers are underperforming, then additional servers can be deployed, the server software can be updated to be more efficient, communication protocols can be changed, or other remedies can be employed. If bugs are found, then the server and/or client code can be patched or redesigned.

Although some examples discussed with respect to FIG. 1A, FIG. 1B, and FIG. 1C were with respect load testing a server with simulated clients that are configured to communicate according to an event model, in other embodiments, the roles can be reversed, and the server can be configured to communicate according to an event model. Although some examples are discussed with respect to particular combinations of hardware or software implementations of servers or clients, other combinations of hardware or software implementations can be used as well.

### Load Testing

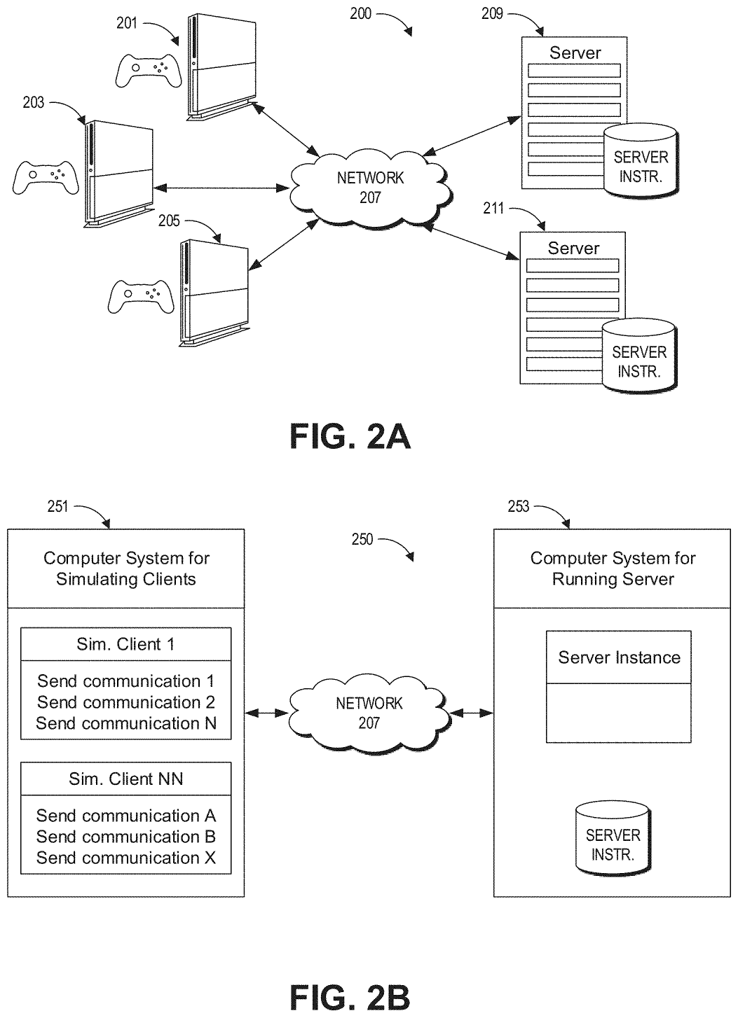

FIG. 2A shows an example system 200 with servers under load. The example system 200 includes a plurality of client devices 201, 203, 205, a network 207 such as the internet or a local area network, and servers 209, 211.

In an operational environment, there can be any number of client devices 201, 203, 205 that connect to servers. Although the client devices 201, 203, 205 are shown as video game consoles, the client devices can be any type of computer system, including personal computers, smartphones, handheld game devices, laptops, and the like.

At any time, a very large number of client devices 201, 203, 205 can connect through network 207 to one or more servers 209, 211. For example, the client devices 201, 203, 205 can include hundreds, thousands, millions, or billions of devices connected to the servers 209, 211 for playing one or more online video games, streaming videos, rendering graphics, accessing data, or other tasks.

The one or more servers 209, 211 can handle a communication load coming from a plurality of client devices. The servers 209, 211 can use one or more hardware processors to execute software comprising server instructions stored on one or more storage devices to determine how to respond to the client load. It can be desirable to test that the software and/or hardware will properly function when a large load of clients are in communication with the servers 209, 211. However, implementing a load test using thousands, millions, or billions of hardware client devices can in many cases be prohibitively expensive.

FIG. 2B shows a test environment 250 for testing servers with a simulated load of clients. The test environment 250 includes a first computer system 251 for simulating clients, a second computer system 253 for running the server, and the network 207.

The second computer system 253 can execute an instance of the server for responding to clients. The performance of the server can be tested and logged. In some embodiments, virtual servers can be instantiated on any computer system. In some embodiments, the computer system for running the server 253 can be the type of computer system that servers will run on when the software is released. For example, servers such as the servers 209 and 211 of FIG. 2A can be used. Accordingly, both the software for the server and the server hardware can be load tested. The computer system 253 can include one or a plurality of servers.

The first computer system 251 can execute a plurality of instances of simulated clients configured to communicate with the server of the second computer system 253. Any number of clients from 1 to N can be simulated. For purposes of load testing, the simulated clients can omit many functions of the actual hardware clients 201, 203, 205. For example, a video game console client might be configured to request status updates from a server, receive the status updates from the server, and process various graphics to show the status updates. For purposes of load testing the server, the simulated clients can be configured to request the status updates from the server and receive (but ignore) the status updates without processing any graphics to show the status update.

Each client can be configured to perform a sequence of events. For load testing, the events can include sending a sequence of communications to the server. For example, simulated client 1 can be configured to send communication 1, then communication 2, and various other communications through communication N, where N can be any number. The distribution and sequence can be the same or vary from simulated client to simulated client. There can be as many as NN other simulated clients, where NN is any number. The sequence and distribution of communications can be determined based on an data structure such as the event model described with respect to FIG. 5. The communications can include, for example, API calls, HTTP calls, function calls, and the like. By being configured to generate a sequence of communications to the server based on an event model, the simulated clients can be implemented without instantiating the actual client software.

As each of the simulated clients 1 through NN send communications, the instance of the server is configured to receive, process, and properly respond to each communication if a response is due. Because the server instance may receive communications from a large number of simulated clients, the server software can be load tested for any errors.

Although FIG. 2B is shown with two separate computer systems 251 and 253, in other embodiments, one computer system can both simulate clients and run an instance of the server. Although one computer system is shown as running one instance of a server, in other embodiments one or more computer systems can run a plurality of instances of the server software where the plurality of servers work together as a server system, such as shown in FIG. 2A. Although one computer system 251 is shown for simulating clients, in other embodiments one or more computer systems 251 can simulate even larger numbers of clients to provide larger loads.

FIG. 3 shows a diagram of a software testing system 300. The system 300 includes a data store including software tests 303, a data store including client software 305, a data store including server software 307, a test environment 309 that includes client instances 311 and server instances 313, test logs files 315, an artificial intelligence system 317, an event model 319, a data store including a load test application 321, a load test environment 323 that includes a server instance 325 and a plurality of simulated clients 327, and load test results 329. One or more programmers 301 and one or more programmers 331 may interact with the software testing system 300.

One or more programmers 301 may write, use, test, and periodically update software. For large software projects, the programmers 301 can include hundreds or thousands of people. In the example embodiment shown in FIG. 3, the software includes both a server component and a client component. The programmers can write, test, and update the client software 305 and/or the server software 307.

To test the software, one or more software tests 303 can be used. The software can be tested for bugs, features and functionality, design, user feedback, and the like. The test software 303 can execute a test environment 309 where at least one client instance 311 and/or at least one server instance 313 is instantiated based on the client software 305 and/or server software 307, respectively. In some cases, test clients 311 can be implemented based on the testing software 303 instead of the client software 305 to test an instance of the server 313 that is instantiated based on the server software 307. In some cases, test servers 313 can be implemented based on the testing software 303 instead of the server software 307 to test an instance of the client 311 that is instantiated based on the client software 305. A variety of tests 303 can be run. The tests 303 can be run periodically (such as overnight, daily, weekly, and the like), routinely, at regular or irregular times, or whenever certain events occur (such as whenever the client software 305 or server software 307 are updated to a newer version).

During the tests, the clients 311 can perform a sequence of events, such as communicating with the server 313. The sequences and times of events, along with other debug information and test results, can be recorded in a test log file 315. The results of the testing can be provided to the programmers 301 to fix bugs in the code, add or remove features and functionality, change the design of the software, change the software in view of user feedback, and make other types of updates to the software 305, 307. The programmers 301 can, for example, review specific sections of failed tests to debug their code.

Large quantities of tests can be executed so that large quantities of test log files are generated. In many software development environments, too many test log files that include too much data are generated too frequently such that it is impossible for one person or even a small group of people in a load test team to manually review the test logs before more test logs are generated and impossibly for the person to manually review the test logs without delaying the software development process. For example, hundreds, thousands, or millions of tests can be performed hourly, daily, or weekly such that hundreds, thousands, or millions of test reports are generated in each period of time, and each of the test reports can include hundreds, thousands, or millions of lines of information such that it is impossible for a person to analyze the test reports in time to update the load test environment before further software updates or before further testing.

The AI system 317 can be configured to analyze the test log files 315. In some embodiments, the AI system 317 can parse the test log files to identify sequences of events in the test log files. The AI system 317 can then compare the identified sequences of events to sequences of events in a previously established event model 319 (for example, as shown in FIG. 5). If the sequences of events in the test log are different from the sequences of events in the event model 319, then the event model 319 can be updated (for example, as shown in FIG. 7) based on the difference. For example, new events can be added, existing events can be removed, new scenarios can be added, existing scenarios can be removed, the ordering of events or scenarios can change, and the like. The distributions of times between events can also be updated or replaced based on the timings that occurred in the test logs. In some embodiments, the AI system 317 can additionally or alternatively compare the identified sequences of events to sequences of events from even earlier test logs to find the differences. Accordingly, the event model 319 can be updated by the AI as frequently as tests 309 are performed and test logs 315 are generated.

A load test application 321 is configured to test the server software 307 to see how the server software will perform under load. The load test applications 321 can be stored as computer instructions on a non-transitory, computer readable storage device. A load test environment 323 is implemented where one or more instances 325 of the server software 307 are instantiated. The server software 307 can be instantiated on actual server hardware, and it can be useful to execute the server software 307 on the actual or similar type of hardware that will be used to run servers once the software is released so that the performance of the hardware can be load tested. To generate a load to the servers 325 in a cost effective manner, a plurality of clients 327 can be simulated, such as discussed with respect to FIG. 2B.

The simulated clients 327 can be instantiated based on instructions from the load test applications 321 instead of instantiating the client software 305. The load test application 321 can configure the simulated clients 327 to perform sequences of events according to the event model 319. For example, the simulated clients 327 can be configured to execute a sequence of events included in the event model. If multiple sequences of events are included, then the sequence of events can be selected according to a distribution or other algorithm in the event model 319. The simulated clients 327 can also be configured to execute the sequence of events according to timing distributions included in the event model 319. By executing sequences of events from the event model, many simulated clients 327 can generate a load for testing the servers 325. Because the event model 319 is usually less complex than the client software 305, the simulated clients 327 are also able to be executed using fewer computer resources (such as less power, fewer computing threads, less memory, and the like).

Based on the load testing, load test results 329 can be generated. Programmers 331 can review the load test results and update any software to fix bugs in the code, add or remove features and functionality, change the design of the software, change the software in view of user feedback, and the like.

### Example User Interface

FIG. 4 shows an example user interface 400. The user interface can be used for recording and logging the execution of software and for identifying and marking scenarios and/or events, such as described with respect to blocks 151 and 153 of FIG. 1B.

The user interface 400 includes a current client system time 401, a software start time 403, a software title 405, a platform 407, an export button 409, an import button 411, a list of scenarios 413, a list of events 415, a video output area 417, playback controls 419, recording controls 421, and a save button 423. The user interface 400 can be used to record and/or watch the playback of software such as a video game. During playback, different events can be tagged or marked as belonging to different scenarios.

The user interface 400 can be displayed on a computer system for recording software usage, such as the playing of a video game. The video game software can be played, for example, on a console, smartphone, personal computer, or any other computer system. The recording controls 421 can be used to start, stop, and skip through recording of the gameplay. When recording the replay, the current system time 401, software start time 403, software title 405, and platform type 407 can be logged, along with the sequence and timing of events 415 executed during play of the video game or during the usage of the software. A video output 417 of the game play or software usage can be recorded as video data included as part of the replay data. In addition or as an alternative to recording the video data, data sufficient for regenerating the game play can be recorded. Such data can include, for example, a sequence of user inputs, game states, and/or a version of the software. The replay data can be exported for storage by clicking the export button 409.

The user interface 400 can also be used to review and tag the events 415 that occurred during video game play or other software usage. After a replay is recorded or replay data is imported by selecting the import button 411, the replay information can be displayed in the user interface 400. This can include displaying the currently system time 401 during the displayed portion 417 of the replay, the replay start time 403, the software title 405, and the platform type 407. The computer system is also configured to display the video output 417 that occurred during the replay. The video output 417 can render the video data included in the replay data, or the video output 417 can regenerate the video output that occurred during the replay by rerunning the stored version of software with the sequence of user inputs and/or game states.

During review, the list of events 415 shows the sequence and timing of the events that occurred during the recorded gameplay. As the replay progresses, the latest executed event can be highlighted or indicated.

A set of controls 419 can be used to advance, stop, or rewind the replay. From left to right, the set of controls include a button to jump to the previous tagged scenario, a button to jump to the previous event, a button to play the replay backwards, a button to pause the replay, a button to play the replay, a button to stop the replay, a button to jump to the next event, and a button to jump to the next tagged scenario. Accordingly, a user is able to use the user interface 400 to progress through the replay and jump forward or backward. The user can also select an event or tagged scenario in the list of events 415, and the video output 417 can update to display the video output that occurred at the time of the selected event or scenario.

Throughout the replay, as the events that occur are indicated in the list of events 415, a user can see what is happening based on the video output 417. The user can click an edit button to add or edit a scenario 413 associated with the events. The scenarios 413 can describe what is happening in the game, such as a login, matchmaking, etc. Each scenario 413 can include one or a sequence of events. For example, a “login” scenario may include the events “Send_Login,” “Login_Success,” and “Process_Login” that occur over several seconds. In the example, the login scenario is followed by a matchmaking scenario.

In some embodiments, the scenarios can initially be blank, and the scenarios can be manually populated. In some embodiments, after a plurality of replays have been manually tagged with scenarios, subsequent replays can be automatically populated with scenario tags based on patterns recognized from the previously tagged plurality of replays. For example, if in a plurality of replays, “Send_Login,” “Login_Success,” and “Process_Login” are tagged as a “login” scenario, then subsequently loaded replays can be automatically analyzed and tagged as part of the “login” scenario. When subsequent replays include unrecognized sequences of events, the unrecognized sequences can be visually indicated, such as with highlighting, markers, stylizing, and the like. A user can then assign a new or existing scenario to the unrecognized sequence of events. After a user has added the scenario tags, the sequence of events annotated with tags can be saved 423.

FIG. 5 shows an example event model 500. Although the example event model 500 is shown as a flowchart or tree, the event model 500 can be structured as any type of data structure. For example, the flowchart can be a web structure, include forward and backward progression, include algorithms or branch decision logic, and the like. The event model 500 includes a plurality of events 501-519. The event model 500 can also include scenario tags 521-525. The event model 500 can also include timing distributions between events and branches 531.

The sequences of events in the event model 500 can be generated based on the sequences of events that occur in a plurality of logs of software execution, such as described in block 151 of FIG. 1B and/or recorded using the user interface 400 of FIG. 4. The sequences of events in the event model 500 can also be generated or supplemented based on logged sequences of events that occur during software testing, such as during block 107 of FIG. 1A, 115 of FIG. 1A, and/or block 157 of FIG. 1B. The events can include communications from a client to a server, commands for a server to process, and the like. For example, events can include API calls, HTTP communications, function calls, and the like. For each event, a client, class, or source can be indicated, as well as the type of command, method, call, communication, instruction being issued, or parameter.

Sequences of events that repeatedly occur in the test logs can be mapped. For example, if a video game software is executed and begins with events 501, 503, and 505 in a plurality of logs, then these events can be included in event model 500 according to the logged sequence. If one or more logs include a sequence of events 507, 509, and 511 occur when a single player mode is selected, then these events can be included as another sequence in the event model 500. If a sequence of events 513, 515, 517, and 519 occur when a multiplayer mode is selected, then these events can be included as another sequence in the event model 500. The logged times and/or distribution of times (such as randomly, normal distribution, historical occurrence, and the like) that elapse between the events can also be included.

The event tree 500 can include a decision branch 531. The decision branch 531 can split from a first event, such as event 505, to a plurality of events, such as events 507 and 513. The branches can indicate different sequences of events that occurred in the logs. For example, after a video game is started, a user may select either a single player mode or a multiplayer mode, and this decision can occur in a plurality of logs. Accordingly, the branch 531 can reflect the frequency that single player or multiplayer scenarios are selected. A simulated client configured to generate events according to the event tree 500 can select a branch of events according to the branch distribution 531.

The event model 500 can also include scenario tags 521, 523, and 525 based on the tags that were added using the user interface 400 of FIG. 4. The tags 521, 523, and 525 are each indicated as being associated with a first event in a related sequence of events. For example, the “Login” tag is associated with event 501, and is related to events 501, 503, and 505. In other embodiments, the tags can be indicated as associated with each event in the related sequence of events.

Accordingly, the event model 500 can be generated based at least in part on logged execution of software. The event model 500 can also be updated as new software executions are logged, such as during software testing. For example, new events can be added, timings and/or their distributions can be updated, new branches can be added when new sequences of events are logged, the probabilities of the branches can be updated as the different branches are taken, and the like. Additionally, any new tags added in the user interface 400 can be added to the event model 500.

FIG. 6 shows a part of an example scenario model 600. A scenario model can be similar to the event model 500 of FIG. 5, except that scenario sequences are shown instead of event sequences. The scenario model 600 can include a plurality of scenarios 601-617 and branches 621-625. The flowchart of scenarios can be generated based on the logged sequences of scenarios that were tagged in the user interface 400 of FIG. 4. The decision branches 621-625 can similarly indicate the frequencies that different orders of scenarios occurred in the logs.

Each of the scenarios 601-617 can be associated with at least one sequence of events. Accordingly, a scenario model 600 that includes or is linked to sequences of events for the included scenarios implements a “zoomed-out” view of an event model. In some embodiments, one scenario can be associated with a plurality of event sequences, such as a main event sequence and variations of the event sequence. The scenario model 600 can be displayed in a user interface, and the scenarios 601-617 can be interacted with to show the sequence of events associated with a selected scenario.

Timings between scenarios can also be included. The timings can be generated and/or updated based on logged software usage (such as described with respect to block 151 of FIG. 1B) or test logs (such as described with respect to block 107 of FIG. 1A and block 159 of FIG. 1B). If available, actual software usage data can be collected, and the timing distributions can be determined based on the actual software usage data. For example, after a video game is released, the users may turn on the video game and then select either single player or multi player. The video game may connect to a server, and the server can collect actual amounts of time that pass between turn on and the selection of single player or multi player. In response, the timings between blocks 601, 603, and 609 can be updated to better reflect real world timings.

FIG. 7 shows a part of an example event model 700 with a new event 701. A plurality of events 703-711 are part of a previously established event model.

In the previously established event model, a plurality of initial events (not shown) can lead to event 703, which is followed by event 705, which is followed by event 707, which is followed by event 709, which is followed by event 711, which can proceed to subsequent events (not shown). The previously established event model can be generated, for example, at block 155 of FIG. 1B or at block 167 during a cycle of FIG. 1B.

The new event 701 can be added as an alternative path. The new event can be detected, for example, during block 161 of FIG. 1B by comparing events from test logs to the previously established event model including events 703-711. Based on the comparisons, it may be discovered that the test logs include event 701 between event 707 and event 709. In response, event 701 can be added. The relative timing of event 701 to event 707 and event 709 can also be added to the event model 700. The frequency that event 701 is present from the test logs can be taken into consideration when updating the event model 700. For example, if some but not all test logs include event 701, then event 707 can be edited to branch to either event 701 or to event 709 according to the frequency that event 701 was present in the test logs. As another example, if all recent test logs include event 701 between event 707 and event 709, then event 701 can instead be added into the sequence between event 707 and event 709.

In some embodiments, the event model 700 can be displayed in a graphical user interface. The data structure of the event model 700 can be represented in a variety of formats, such as the flowchart of FIG. 7, as a table, as code structures, and the like. The graphical user interface can use a visual indicator, such as different markings, highlighting, and the like, to draw attention to the new events. In some embodiments, the graphical user interface can be configured to receive a user confirmation about whether to update event model 700 to include each new event. In some embodiments, the graphical user interface can show a video of output from the software being used, similar to the video output area 417 of FIG. 4 alongside each new event. This allows a person to see what the software was doing when the new event 701 occurs so that the person can decide whether or not the event model 700 should be updated to include the new event 701. In response to receiving a confirmation, the new event 701 can be added to the event model 700 as a replacement or alternative path. In response to receiving a rejection, the new event 701 can be omitted from the event model 700. In some embodiments, the new event 701 can be automatically added to the event model 700 without user confirmation or added by default in the absence of user confirmation.

FIG. 8 shows a part of an example event model 800 where a plurality of new events are added as part of a new scenario. A plurality of events 801-813 are part of a previously established event model. A sequence of new events 815-825 tagged as part of a new scenario 827 are being added to the event model 800.

The previously established event model includes a sequence of events 801-809. The previously established event model also includes a first branch from 803 to either event 811 or event 805 and a second branch from event 811 to either event 813 or event 803. As structured, the established event model includes two loops that can be taken and repeated a number of times as part of a sequence of events.

From event 813, the new sequence of events 815-825 are added. The new sequence of events 815-825 can be detected, for example, during block 161 of FIG. 1B by comparing events from test logs to the previously established event model including events 801, 803, 811, and 813. Based on the comparisons, it may be discovered that one or a plurality of test logs include events 815-825 following event 813. In response, events 815-825 can be added as a separate path in the event model 800. The relative timings of events 815-825 can be added as well. The frequency that events 815-825 occur after event 813 can be added as well.

Additionally, it can be recognized that the plurality of events 815-825 may be part of a new scenario. This can be determined based at least in part on the fact that events 815-825 include a plurality of events that do not quickly merge back into a sequence of events in a previous scenario. In response to the determination, event 815 can be tagged as the start of a new scenario.

In some embodiments, the new scenario 827 tag and/or the plurality of events 815-825 can be displayed in a graphical user interface. The graphical user interface can use a visual indicator, such as different markings, highlighting, and the like, to draw attention to the new events 815-825 and the new scenario 827. In some embodiments, the graphical user interface can be configured to receive a user confirmation about whether to update event model 800 to include the new events 815-825. In some embodiments, the graphical user interface can show a video of output from the software being used, similar to the video output area 417 of FIG. 4 alongside each new event. This allows a person to see what the software was doing when the new events 815-825 occurs so that the person can decide whether or not the event model 800 should be updated to include the new events 815-825. In response to receiving a confirmation, the new events 815-825 can be added to the event model 800 as a replacement or alternative path. In response to receiving a rejection, the new events 815-825 can be omitted from the event model 800. In some embodiments, the new events 815-825 can be automatically added to the event model 800 without user confirmation or added by default 800 in the absence of user confirmation. As part of the display in the graphical user interface, a user can be prompted to confirm that the new scenario 827 is proper, prompted to confirm that the location of the tag for the new scenario 827 is proper, and prompted for a description of the scenario 827.

The examples of changes to the event models 700 and 800 are similarly applicable to scenario models.

### Additional Embodiments and Disclosure

The techniques disclosed herein can be used to perform other types of testing.

For example, FIG. 3 shows a system configured for load testing a server. However, the roles of the client and server can be reversed. For example, an event model 319 can be created for a server. The test environment 323 can be modified so that a client instance of the software 305 can be tested against different simulations of servers. The client instance may receive, for example different responses and/or responses at different times according to different event models 319 for the server.

As another example, the system of FIG. 3 can be modified such that the load tests 321 include instructions to simulate clients 327 to execute user-specified sequences of scenarios, such as shown in FIG. 6. Each scenario in the sequence of FIG. 6 can correspond to one or a plurality of events. For example, load tests can be specified to simulate 100,000 clients that execute the scenario sequence of: new game started, then start multi player, then login, then matchmaking, then victory.

The technology disclosed herein can also be used to provide coverage testing. For example, event models can be generated based on test logs and/or software usage. Tests can be configured to run through all known sequences of events for coverage testing, regardless of how frequently the events occurred.

### Example Hardware Configuration of Computing System

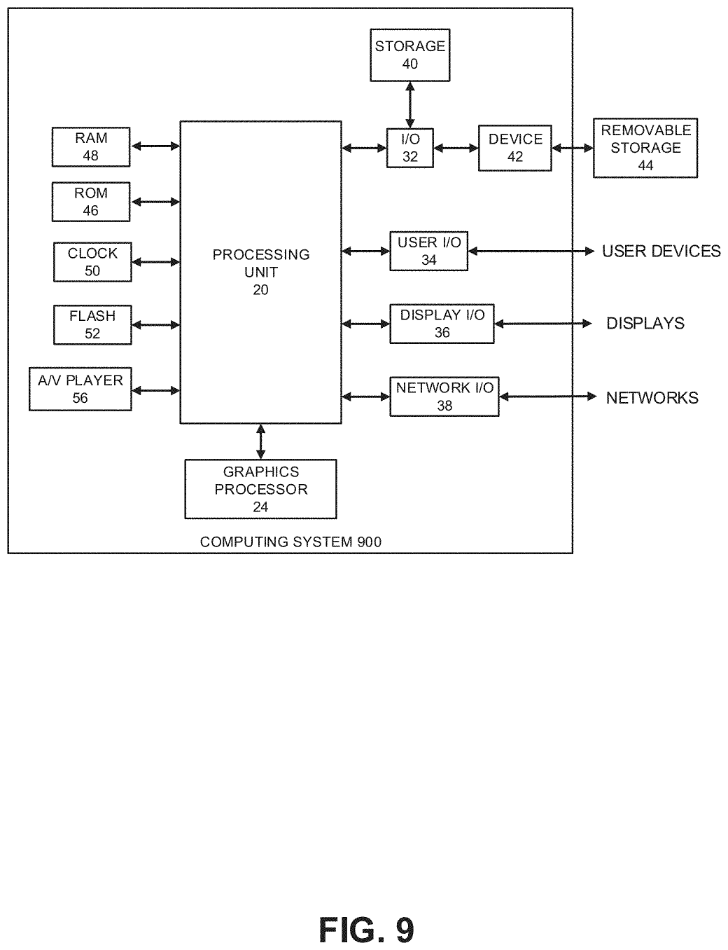

FIG. 9 shows an embodiment of a hardware configuration for a computing system 900, such as the computing systems 251 or 253 shown in FIG. 2B or a computing system configured to perform blocks 161, 163, and 167 of FIG. 1B. Other variations of the computing system 900 may be substituted for the examples explicitly presented herein, such as removing or adding components to the computing system 900. The computing system 900 may include a computer, a server, and the like. FIG. 9 does not simply represent any generic computer system. For instance, in the example embodiment of FIG. 2B, the computer system 251 can be implemented as the computer system 900 of FIG. 9 for simulating events from a plurality of video game consoles instead of being the actual plurality of video game consoles as shown in FIG. 2A.

As shown, the computing system 900 includes a processing unit 20 that interacts with other components of the computing system 900 and also components external to the computing system 900. A game media reader 22 may be included that can communicate with game media 12. Game media reader 22 may be an optical disc reader capable of reading optical discs, such as CD-ROM or DVDs, or any other type of reader that can receive and read data from game media 12. In some embodiments, the game media reader 22 may be optional or omitted. For example, game content or applications may be accessed over a network via the network I/O 38 rendering the game media reader 22 and/or the game media 12 optional.

The computing system 900 may include a separate graphics processor 24. In some cases, the graphics processor 24 may be built into the processing unit 20, such as with an APU. In some such cases, the graphics processor 24 may share Random Access Memory (RAM) with the processing unit 20. Alternatively, or in addition, the computing system 900 may include a discrete graphics processor 24 that is separate from the processing unit 20. In some such cases, the graphics processor 24 may have separate RAM from the processing unit 20. Further, in some cases, the graphics processor 24 may work in conjunction with one or more additional graphics processors and/or with an embedded or non-discrete graphics processing unit, which may be embedded into a motherboard and which is sometimes referred to as an on-board graphics chip or device.

The computing system 900 also includes various components for enabling input/output, such as an I/O 32, a user I/O 34, a display I/O 36, and a network I/O 38. As previously described, the input/output components may, in some cases, include touch-enabled devices. The I/O 32 interacts with storage element 40 and, through a device 42, removable storage media 44 in order to provide storage for the computing system 900. The storage element 40 can store a database that includes the images, test logs, feedback, models, and the like. Processing unit 20 can communicate through I/O 32 to store data, such as game state data and any shared data files. In addition to storage 40 and removable storage media 44, the computing system 900 is also shown including ROM (Read-Only Memory) 46 and RAM 48. RAM 48 may be used for data that is accessed frequently, or for all data that is accessed by the processing unit 20 and/or the graphics processor 24.

User I/O 34 is used to send and receive commands between processing unit 20 and user devices. In some embodiments, the user I/O 34 can include touchscreen inputs. As previously described, the touchscreen can be a capacitive touchscreen, a resistive touchscreen, or other type of touchscreen technology that is configured to receive user input through tactile inputs from the user. Display I/O 36 provides input/output functions that are used to display images. Network I/O 38 is used for input/output functions for a network. Network I/O 38 may be used during execution of software.

Display output signals may be produced by the display I/O 36 and can include signals for displaying visual content produced by the computing system 900 on a display device, such as graphics, user interfaces, video, and/or other visual content. The computing system 900 may comprise one or more integrated displays configured to receive display output signals produced by the display I/O 36, which may be output for display to a user. According to some embodiments, display output signals produced by the display I/O 36 may also be output to one or more display devices external to the computing system 900.

The computing system 900 can also include other features such as a clock 50, flash memory 52, and other components. An audio/video player 56 might also be used to play a video sequence, such as a replay of software usage. It should be understood that other components may be provided in the computing system 900 and that a person skilled in the art will appreciate other variations of the computing system 900.

Program code can be stored in ROM 46, RAM 48, or storage 40 (which might comprise hard disk, other magnetic storage, optical storage, solid state drives, and/or other non-volatile storage, or a combination or variation of these). At least part of the program code can be stored in ROM that is programmable (ROM, PROM, EPROM, EEPROM, and so forth), in storage 40, and/or on removable media (which can be a CD-ROM, cartridge, memory chip or the like, or obtained over a network or other electronic channel as needed). In general, program code can be found embodied in a tangible non-transitory signal-bearing medium.

Random access memory (RAM) 48 (and possibly other storage) is usable to store variables and processor data as needed. RAM is used and holds data that is generated during the software execution. Generally, RAM 48 is volatile storage and data stored within RAM 48 may be lost when the computing system 900 is turned off or loses power.

Although data is described as being found in RAM 48, it will be understood that data does not have to be stored in RAM 48 and may be stored in other memory accessible to processing unit 20 or distributed among several media, such as game media 12 and storage 40.

It is to be understood that not necessarily all objects or advantages may be achieved in accordance with any particular embodiment described herein. Thus, for example, those skilled in the art will recognize that certain embodiments may be configured to operate in a manner that achieves, increases, or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in certain different sequences, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, and the like, may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flowchart diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A computer system for automatically updating load tests, the computer system comprising:
one or more non-transitory, computer-readable storage mediums storing computer readable instructions; and
one or more processors configured to execute the computer readable instructions to perform operations comprising:
accessing application test logs generated based on an updated version of software;
comparing events from the application test logs to events in a previous event model;
based at least in part on the comparison, generating an event model with at least one update to the previous event model; and
load testing one or more servers, wherein the load testing includes:
instantiating a plurality of simulated clients, each simulated client configured to execute a test application that causes the simulated client to send communications with the one or more servers according to the events in the event model, wherein the communications are a load to the one or more servers; and
processing, by the one or more servers, the communications sent by the simulated clients.

2. The computer system of claim 1, wherein the one or more processors are configured to execute the computer readable instructions to perform operations further comprising:
performing a plurality of tests on the software, wherein a test client communicates to a test server during the tests; and
generating the application test logs that include the events and times that the events occurred, wherein the events include communications sent from the test client to the test server.

3. The computer system of claim 1, wherein the event model includes a plurality of branches splitting events in the event model into various paths of events.

4. The computer system of claim 3, wherein the event model further includes:
indications of timings for the events in the event model; and
statistical distributions of how often the various paths of events are taken.

5. The computer system of claim 1, wherein the at least one update includes at least one of:
a new event in the event model;
a new branch in the event model;
a changed order of events in the event model;
a changed branch probability in the event model; or
a changed timing of an event in the event model.

6. The computer system of claim 1, wherein:
one or more new events are identified based on the comparison, the one or more new events occurring in at least one of the application test logs due and being missing from the previous event model; and
wherein the at least one update includes the one or more new events.

7. The computer system of claim 6, wherein:
the one or more new events occur after a scenario in some but not all of the application test logs; and
the at least one update includes the one or more new events as a new branch in the event model.

8. The computer system of claim 1, wherein the one or more processors are configured to execute the computer readable instructions to perform operations further comprising:
receiving a plurality of tagged application test logs, each tagged application test log including a plurality of scenario tags, each scenario tag applied to a sequence of one or more events; and
generating the previous event model based on the tagged application test logs, the previous event model including branch statistics based on the tagged application test logs.

9. The computer system of claim 8, wherein:
the application test logs are compared to the previous event model to determine a new scenario not present in the previous event model, the new scenario including a sequence of events; and
the at least one update includes the new scenario.

10. The computer system of claim 9, wherein the one or more processors are configured to execute the computer readable instructions to perform operations further comprising:
generating data for displaying a graphical user interface showing at least two of:
a video output of the software while the new scenario is being executed;
events included in the new scenario; and
portions of the event model included in the at least one update.

11. The computer system of claim 9, wherein the one or more processors are configured to execute the computer readable instructions to perform operations further comprising:
receiving an indication of at least one of: a confirmation that the new scenario is correct or a tag describing the new scenario.

12. A method for an artificial intelligence system to provide load testing, the method comprising:
accessing application test logs generated based on an updated version of software;
comparing events from the application test logs to events in a previous event model;
based at least in part on the comparison, generating an event model that includes at least one update to the previous event model; and
load testing one or more servers, wherein the load testing includes:
running the one or more servers;
instantiating a plurality of simulated clients, each simulated client configured to execute a test application that causes the simulated clients to send communications to the one or more servers according to events in the event model, wherein the communications are a load on the one or more servers; and
processing by the one or more servers, the communications sent by the simulated clients.

13. The method of claim 12, further comprising:
performing a plurality of tests on the software, wherein a test client communicates to a test server during the tests; and
generating the application test logs that include the events and times that the events occurred, wherein the events include communications sent from the test client to the test server.

14. The method of claim 12, wherein the event model includes a plurality of branches splitting the events in the event model into various paths of events.

15. The method of claim 14, wherein the event model further includes:
indications of timings for the events in the event model; and
statistical distributions of how often the various paths of events are taken.

16. The method of claim 12, wherein the at least one update includes at least one a new event in the event model;
a new branch in the event model;
a changed order of the events in the event model;
a changed branch probability in the event model; or
a changed timing of an event in the event model.

17. The method of claim 12, wherein:
one or more new events are identified based on the comparison, the one or more new events occurring in at least one of the application test logs due and being missing from the previous event model; and
wherein updating the event model includes adding the one or more new events to the event model.

18. The method of claim 12, further comprising:
receiving a plurality of tagged application test logs, each tagged application test log including a plurality of scenario tags, each scenario tag applied to a sequence of one or more events; and
generating the previous event model based on the tagged application test logs, the previous event model including branch statistics based on the tagged application test logs.

19. The method of claim 18, wherein:
the application test logs are compared to the previous event model to determine a new scenario not present in the previous event model, the new scenario including a sequence of events; and
the at least one update includes the new scenario.

20. The method of claim 19, further comprising:
generating data for displaying a graphical user interface showing at least two of:
a video output of the software while the new scenario is being executed;
events included in the new scenario; and
portions of the event model included in the at least one update.
